(19) United States
(12) Patent Application Publication
(10) Pub. No.: US 2015/0269515 A1
(43) Pub. Date: Sep. 24, 2015

(54) VIRTUAL OBJECTS WITH ENTITLEMENTS

(71) Applicant: Sony Computer Entertainment America LLC, San Mateo, CA (US)

(72) Inventor: Edward Adam Lerner, San Francisco, CA (US)

(73) Assignee: Sony Computer Entertainment America LLC, San Mateo, CA (US)

(21) Appl. No.: 14/221,332

(22) Filed: Mar. 21, 2014

(51) Int. Cl. G06Q 10/08; A63F 13/792; G06Q 50/34

(52) U.S. Cl. CPC G06Q 10/087; G06Q 50/34; A63F 13/792

(57) ABSTRACT

Computer-implemented methods and systems for processing of secondary entitlements are provided. An example method includes registering a virtual object with a digital store to create secondary entitlement data, and registering a user with the digital store to create a user account. The user's initial list of secondary entitlements is created. As the user acts within the digital world, application or platform their actions are monitored for acquiring, using and removal of virtual objects with secondary entitlements. Each acquired virtual object is checked for secondary entitlements, and if so added to the users list of secondary entitlements. Each removed virtual object is checked for secondary entitlements, and if so removed from the users list of secondary entitlements. Uses of the secondary entitlements, either inside the digital platform or in the larger outside world, is also watched, and the list of available secondary requirements is updated as necessary.

### TECHNICAL FIELD

This disclosure relates generally to data processing, and more specifically to methods and systems for acquiring new software applications which have additional entitlements associated therewith.

### BACKGROUND

Increasingly there is crossover between the console gaming business and the much larger gambling business. People are interested in combining the skill and competition of games, and the excitement and attractive rewards of gambling.

In most places for-profit competitive games with real-world prizes are legal including professional sports and motorsports, dancing and singing contests, game shows and reality shows. Beyond televised competitions there are more prizes associated with contests such as poker, bridge and chess tournaments, even eating competitions. Prizes capture our interest, even if it is for killing terrorists ($25 million for Osama Bin Laden) or capturing common criminals.

While people love contests and prizes, the contests and/or the prizes may be regulated. In some jurisdictions it is not legal to offer certain kinds of contests with real world prizes that require a cash fee for entry. In non-electronic contests this jurisdictional limitation is often worked around by offering entry into a contest along with a purchase, a visit to a store or a self addressed stamped envelope. For instance McDonalds offers tickets to a Monopoly contest by either visiting a store or mailing in a letter requesting a ticket.

The present invention provides a reward or prize (entitlement) by way of a virtual object.

### SUMMARY

This summary is provided to introduce a selection of concepts in a simplified form that are further described below. This summary is not intended to identify key features or essential features of the claimed subject matter, nor is it intended to be used as an aid in determining the scope of the claimed subject matter.

The invention is directed to virtual objects having entitlements.

In particular, a computer implemented method for processing entitlements of virtual objects includes the steps of: registering virtual objects with a digital store to create virtual object data, determining if entitlements are associated with each virtual object; registering a user with the digital store to create user data; determining which entitlements are associated with the user based on the user data and the virtual object data; receiving, from external sources based on user actions, updated status on the entitlements acquired by the user and updated status on the entitlements used by the user; updating the user data for the entitlements associated with the user; and displaying the entitlements to the user.

The method further includes the user acquiring virtual objects while playing a computer implemented game.

Additionally, the entitlements associated with the virtual objects can be redeemed for real-world objects and/or services.

The entitlements can be bought by a user from the digital store.

The entitlements associated with the virtual object can be redeemed for game-world objects and/or services.

The number of entitlements associated with a virtual object may change based on a variable factor within the game.

The entitlements are for use with a different application or game.

The user is allowed to sell or transfer the entitlements to another user based on rules of the game or gaming platform.

The entitlements must be used within a predetermined period of time.

To the accomplishment of the foregoing and related ends, the one or more embodiments comprise the features hereinafter fully described and particularly pointed out in the claims. The following description and the drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Embodiments are illustrated by way of example and not limitation in the figures of the accompanying drawings, in which like references indicate similar elements and in which:

FIG. 1 is a block diagram showing an environment within which a method and system for secondary entitlements can be implemented, in accordance with an example embodiment.

FIG. 2 shows a flow chart of a method for processing secondary entitlements, in accordance with some example embodiments.

FIG. 3 shows a detailed block diagram of the system for processing secondary entitlements, in accordance with an example embodiment.

FIG. 4 shows a further detailed block diagram of one of the steps of FIG. 2.

FIG. 5 shows a diagrammatic representation of a computing device for a machine in the exemplary electronic form of a computer system, within which a set of instructions for causing the machine to perform any one or more of the methodologies discussed herein, can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

An alternative to selling or giving tickets to contests is to create virtual objects (a cool virtual hat, for instance) that also have the property as acting as a ticket to a contest with prizes. Alternatively the virtual object could include entitlements to other items. For instance buying a God of War (trademark) hat in Little Big Planet (trademark) might allow you to enter a God of War (trademark) event. The entitlements might be initially hidden from the user, for instance the user might not know whether buying the God of War (trademark) hat will get him or her a free game, or a free month of PlayStation (trademark) plus, or just be a hat.

In this invention, a game virtual object can have more than one property or entitlement. It is common in games that a golden ring not only looks nice, but also offers the property of making the wearer invisible. One novel element in this invention is that these properties may also have real world affects, subsequently known as real world entitlements or simply entitlements. For instance a virtual red hat in Little Big Planet (trademark) could have the property of acting as a one-shot $2 off coupon for any purchase of more than $10 in Little Big Planet (trademark) objects.

Another possibility is something like Willy Wonka's (trademark) golden ticket. For instance, a virtual candy bar in Grand Theft Auto (trademark) game could contain an entitlement to tour Sony's studios, to enter a contest, or win a free game.

These virtual tickets are particularly useful when the object or service that you wish to offer is limited in number or amount, or that selling that object or service directly may be restricted by law or practical considerations. For instance it may be forbidden in some locals to sell tickets to minors to contests that have cash or real world prizes, but still be legal to sell a magical weapon that has the second property of enabling the owner to be granted a ‘free’ ticket to a contest.

These additional properties can be ongoing or single-use. They can be locked to the virtual object, or can be separated from the virtual object. They can be locked to the buyer of the virtual object, or transferrable to other parties. Potentially they can be purchased or acquired separately from the virtual object, or through some item enhancement process be merged with the virtual object to create a virtual object with additional properties.

These are examples of how, in the context of an electronic game or application, more efficient methods of contest entry or other entitlements are possible. More generally this invention covers a system to enable electronic application to offer additional entitlements contained within virtual objects. These additional entitlements could be varied. They might be tickets to enter contests, prizes within the game or application world, real world prizes, or coupons offering discounts for real world or game world items.

For example, Uncharted (trademark), an application by Sony Computer Entertainment, is a popular shooting game.

One method to enter an Uncharted (trademark) contest could be to buy a bandoleer of Special Contest Ammunition for a small fee, say one dollar. Not only could that bandoleer act as ammunition within the Uncharted (trademark) game, it could also contain an additional entitlement, perhaps a one-time ticket to enter a designated contest.

If the application maker so desired they could then enable that ticket to enter the player into an Uncharted (trademark) tournament with a cash prize to the winners of that contest.

Alternatively a full Uncharted (trademark) game package (whether purchased physically or via download) could include one or more additional entitlements or virtual objects, any of which could include tickets or entitlements for additional virtual objects or entry into contests, which could include cash or other real-world prizes. These virtual objects could automatically be granted to the player, say at the start of the game, or only be available by navigating through the game world or completing some in-game mission.

Alternatively there does not have to be a one-to-one tie between purchasing a virtual good or virtual item and an additional entitlement. A virtual good could contain one or more additional entitlements, or contain no additional entitlement based on a variable factor within the game/platform. A degree of uncertainty over what additional virtual goods or properties a virtual object contains may provide additional excitement to the player.

The additional entitlements contained in one application do not have to be limited to only having properties within the same application. Purchasing or acquiring a virtual army helmet in Uncharted (trademark) could include an entitlement for entry into a different game's contests or a different application's contest, or an entitlement to another game's virtual objects, to encourage the player to try that other application, or an entitlement associated with the application platform, for instance a PlayStation (trademark) Plus membership.

Associating additional entitlements with purchasing or acquiring an application or an application's virtual objects is described hereinafter. In short, the association of additional entitlements after acquisition of an application or virtual object is referred hereinafter as ‘a secondary entitlements.’

An entitlement in a virtual world, platform or application is the real-world equivalent of a title registry for a house, a bookkeeping device that determines if a particular user owns a particular digital right. For instance if a player purchases a game then this means the player has acquired an entitlement to that game. If a player purchases or otherwise acquires a special magic sword for a game, the player has acquired an entitlement to that sword. Entitlements are stored in the appropriate database of the application, the user's account for that application, or the user's account for that application platform.

An entitlement can be represented either as a purchase or acquisition in the user's list of application or platform items, or by an item in the game's or application's virtual world, or in various accounting displays or lists, or may not be visible to the player or user.

When a user purchases or acquires a virtual item, either an item included in the default set of items for a purchaser of the application, or as the item is acquired through an digital store, or within a game or application context, that virtual good may also include entitlements for additional virtual objects or services, or real world objects or services. One possible real world service that may be offered as part of a virtual object is a ticket to a game contest with real world prizes, that is cash or other prizes of real value.

The player may or may not be allowed to sell or transfer either that entitlement or the combination of virtual object and entitlement depending on the rules of either the game or of the gaming platform.

If a virtual object contains or includes one or more additional entitlements then the representation of that object, whether in text or visually may show all, some or none of the additional entitlements.

If the entitlement is time based, perhaps for a contest that starts and ends at a certain time, then the object's visual representation may also contain some user interface elements indicating when that time will come, or if that time has passed. This could be as simple as a count down clock, i.e. “7 days, 11 hours, 4 minutes, 22 seconds to the next Uncharted (trademark) contest.”

In accordance with one embodiment of the invention, a system for offering additional entitlements with a virtual object is provided. The system may comprise a processor and a database.

The processor may be configured to register a virtual object with a digital store to extract, from the virtual object, additional entitlements. The digital store may be associated with the platform or application. Additionally, the processor may be configured to register a user with the digital store to create a user account.

As the user acts within the game world, platform or application, virtual objects may be added, or subtracted from the user's account, depending on actions of the application or user. These changes will be tracked in an appropriate data base.

Either within the application or outside of it, the user may spend, use or transfer these additional entitlements. All changes to the user's additional entitlements may be tracked by the appropriate database.

For instance if the bandoleer of contest ammunition is used to enter the related game contest, the entitlement that enables the owner to use that bandoleer to enter the contest would be removed and that bandoleer might disappear or be shown as used.

If the entitlements are not guaranteed, that is, if exactly what additional entitlement come with the acquisition of a virtual object is not known to the user, then the system may inform the user of what additional entitlement the user has acquired at the point of acquisition or when the user examines the virtual object by whatever means. For instance the user might click on the virtual object once acquired to see what additional entitlements it contains, or the textual or visual description of the virtual object may include its additional properties.

Alternatively the process of acquiring a single virtual object may in fact grant to the player or user multiple virtual objects, for instance a bandoleer of ammunition and a multiple contest ticket.

The approaches and principles disclosed herein relate to computer-implemented methods and systems for processing of the time to begin using or playing an Application delivered online via a digital store.

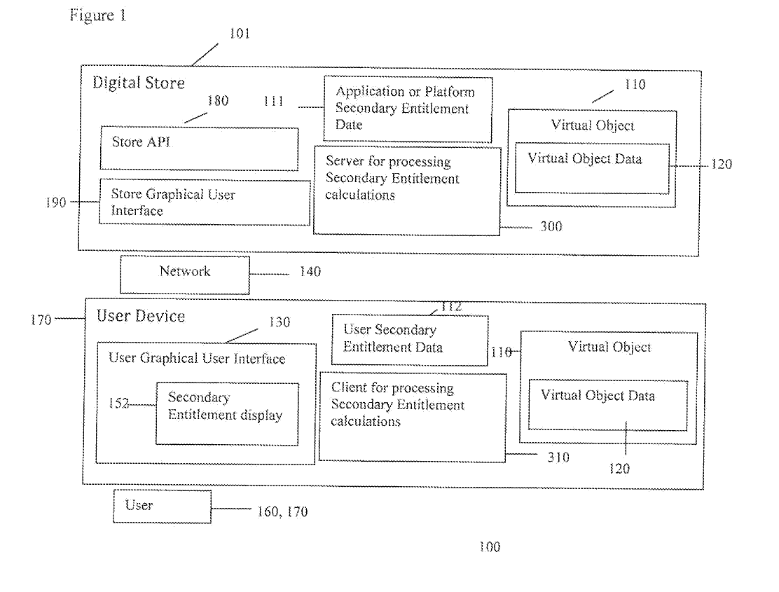

FIG. 1 is a block diagram showing an example environment 100 within which a method and system for processing of secondary entitlements can be implemented. The example environment 100 may include a Digital Store 101, a Virtual Object 110, Application or Platform Secondary Entitlement Data 111, User Secondary Entitlement Data 112, Virtual Object Data 120, a graphical user interface 130, Network 140, Secondary Entitlement display 150, User 160, User Device 170, Digital Store Application Programming Interface 180, Digital Store Graphical User Interface 190. The User graphical user interface 130 and store application programming interface 180 may be associated with a server system for processing secondary entitlements calculations 300 enabling display of the secondary entitlements associated with a User 160. The graphical user interface 130 is for communicating with individuals, whereas the application-programming interface is for communicating with computers. A user 160 may access an online resource associated via a network 140 or through a user device 170.

The network 140 may include the Internet or any other network capable of communicating data between devices.

The user device 170 may include a mobile telephone, a computer, a laptop, a smart phone, a tablet PC, and so forth. The user 160, in some example embodiments, may be a person interacting with the graphical user interface (GUI) 130 via one of the user devices 170. The user 160 may be registered with the system for processing of secondary entitlements calculation 300 and have information on available sizes and times of the applications in the Digital store stored in a database of the system for calculating secondary entitlements 300.

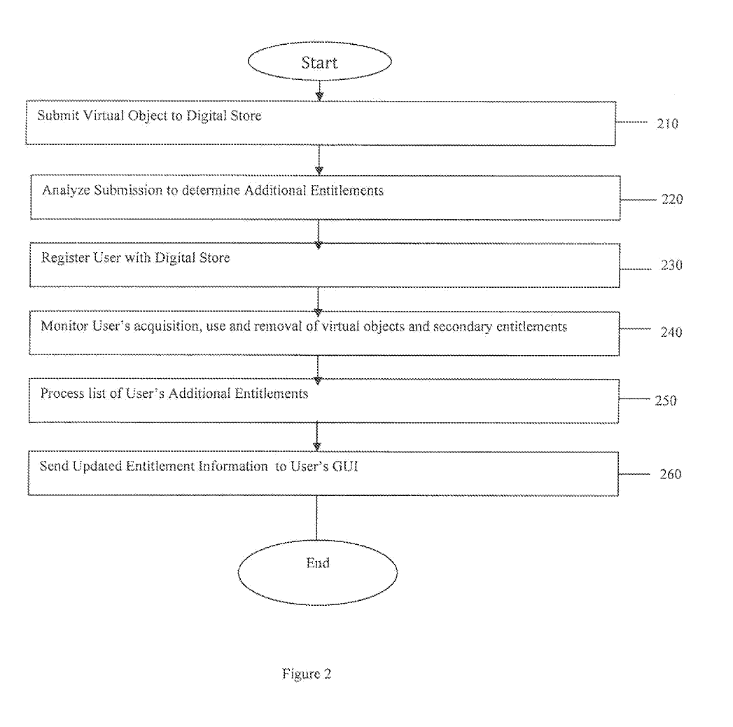

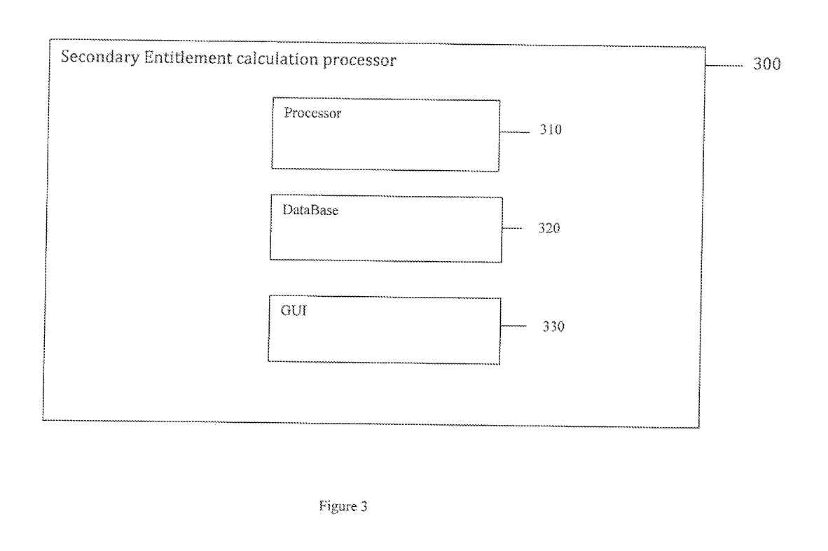

FIG. 2 shows a flow chart of a method 200 for processing of a secondary entitlements calculation. The method 200 may be performed by processing logic that may comprise hardware (e.g., dedicated logic, programmable logic, and microcode), software (such as computer code executable on a general-purpose computer system or a specifically configured computer system), or a combination of both. In one example embodiment, the processing logic resides at the system 300 illustrated in FIG. 3. The method 200 may be performed by the various modules discussed above with reference to FIG. 3. Each of these modules may comprise processing logic.

As shown in FIG. 2, the method begins at Step 210 in which one or more virtual objects associated with a game or application are submitted to a digital store to create virtual object data. In Step 210, the virtual objects are analyzed (see FIG. 3, processor 310) to determine if one or more entitlements are associated with each virtual object. The virtual objects and its associated entitlements are then stored in a database (see FIG. 3, database 320). At Step 230, a user registers with the digital store to create user data. The user information, in association with a game or application, is stored in a database. In Step 240, the user's acquisition of virtual objects, use and removal of virtual objects and use and removal of secondary entitlements are monitored. This is done by determining which secondary entitlements the user has based on user data and the virtual object data. Status updates on the use of the secondary entitlements and acquisition and use of virtual objects is received from external sources or platform applications. Thus, the updated status on the use of secondary entitlements is acquired. In Step 205, based on user action with the platform, etc., the user's secondary entitlements are updated and stored in the database. In Step 260, based on a user's request or application/platform rule, secondary entitlement information is sent to the user's graphical user interface for display.

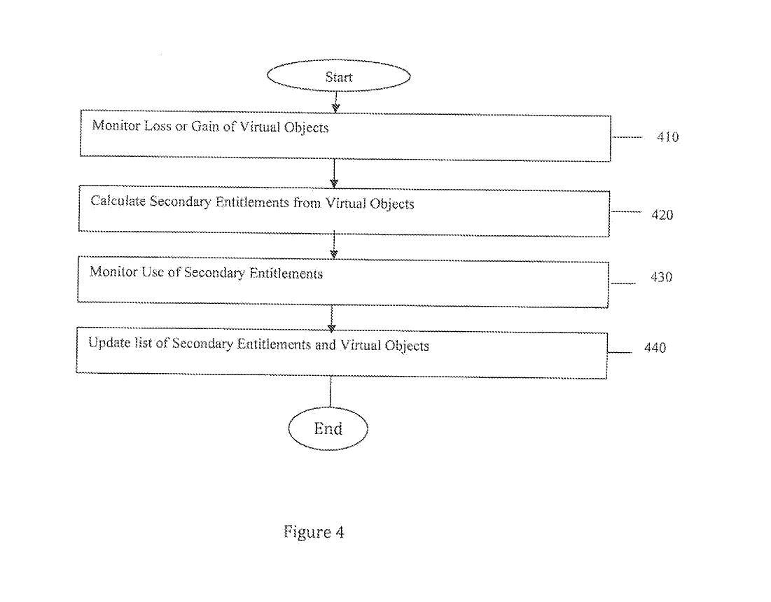

FIG. 4 shows a more detailed explanation for Step 240 in FIG. 2. First, in Step 410, gain or loss of virtual objects during playing of the game is monitored. Each acquired virtual object is examined to determine if the secondary entitlements are associated therewith in Step 420. Once a secondary entitlement is acquired, the use or expiration of the secondary entitlement is monitored in Step 430. Finally, the list of virtual objects and associated secondary entitlements are updated for the user in Step 440.

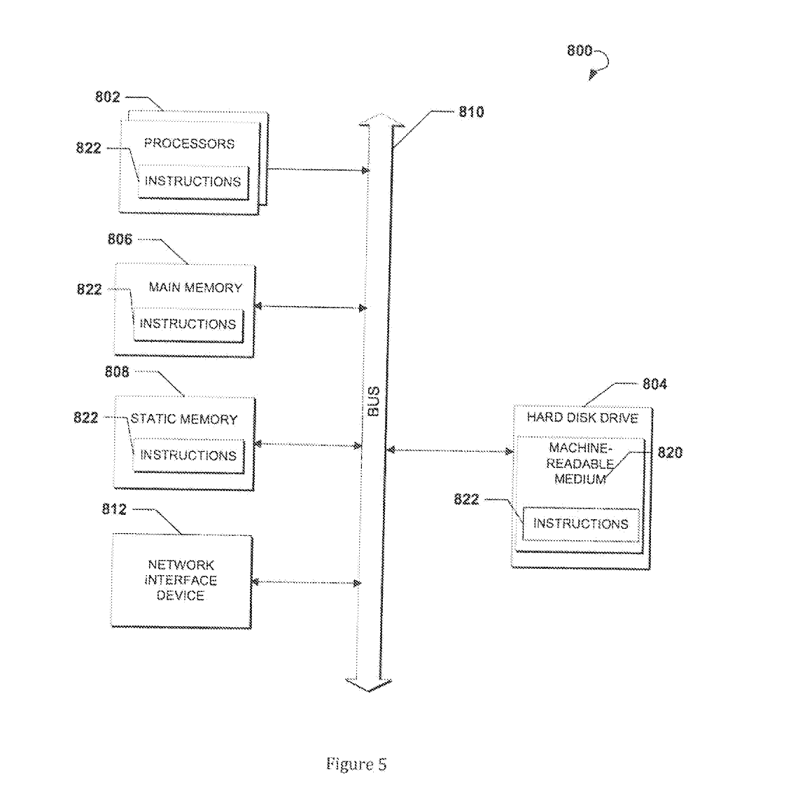

FIG. 5 is a diagrammatic representation of an example machine 800 in the form of a computer system within which a set of instructions for causing the machine to perform any one or more of the methodologies discussed herein is executed. In various example embodiments, the machine operates as a standalone device or may be connected (e.g., networked) to other machines. The machine may include its own internal database or be connected to an external database in order to provide substantially real time updates. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example machine 800 includes a processor or multiple processors 802 (e.g., a central processing unit (CPU), a graphics processing unit (GPU), or both), a main memory 806, and a static memory 808, which communicate with each other via a bus 810. The computer system 800 may further include a video display unit (e.g., a liquid crystal display (LCD) not shown). The computer system 800 may also include an alphanumeric input device (e.g., a keyboard), a cursor control device (e.g., a mouse), a voice recognition or biometric verification unit (not shown), a disk drive unit 809, a signal generation device (e.g., a speaker), and a network interface device 812. The machine 800 may further include a data encryption module (not shown) to encrypt data.

The disk drive unit 804 includes a computer-readable medium 820 on which is stored one or more sets of instructions and data structures (e.g., instructions 822) embodying or utilizing any one or more of the methodologies or functions described herein. The instructions 822 may also reside, completely or at least partially, within the main memory 806 and/or within the processors 802 during execution thereof by the machine 800. The main memory 806 and the processors 802 may also constitute machine-readable media.

The instructions 822 may further be transmitted or received over a network via the network interface device 812 utilizing any one of a number of well-known transfer protocols (e.g., Hyper Text Transfer Protocol (HTTP)). While the computer-readable medium 820 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A computer implemented method for processing entitlements of virtual objects, the method comprising the steps of:
registering virtual objects with a digital store to create virtual object data;
determining if entitlements are associated with each virtual object;
registering a user with the digital store to create user data;
determining which entitlements are associated with the user, based on the user data and the virtual object data;
receiving, from external sources based on user actions, updated status on the entitlements acquired by the user and updated status on the entitlements used by the user;
updating the user data for the entitlements associated with the user; and
displaying the entitlements to the user.

2. The method according to claim 1, wherein the user acquires virtual objects while playing a computer implemented game.

3. The method according to claim 1, wherein the entitlements associated with the virtual objects can be redeemed for a real-world objects and/or services.

4. The method according to claim 1, wherein the entitlements can be bought by a user from the digital store.

5. The method according to claim 1, wherein the entitlements associated with the virtual object can be redeemed for game-world objects and/or services.

6. The method according to claim 1, wherein the number of entitlements associated with a virtual object may change based on a variable factor within the game.

7. The method according to claim 1, wherein the entitlements are for use with a different application or game.

8. The method according to claim 1, wherein the user is allowed to sell or transfer the entitlements to another user based on rules of the game or gaming platform.

9. The method according to claim 1, wherein the entitlements must be used within a predetermined period of time.

10. A non-transitory computer-readable medium comprising the instructions, which when executed by one or more processor, perform the steps of:
registering virtual objects with a digital store to create virtual object data;
determining if entitlements are associated with each virtual object;
registering a user with the digital store to create user data;
determining which entitlements are associated with the user, based on the user data and the virtual object data;
receiving, from external sources based on user actions, updated status on the entitlements acquired by the user and updated status on the entitlements used by the user;
updating the user data for the entitlements associated with the user; and
displaying the entitlements to the user.

11. The medium according to claim 10, wherein the user acquires virtual objects while playing a computer implemented game.

12. The medium according to claim 10, wherein the entitlements associated with the virtual objects can be redeemed for a real-world object and/or service.

13. The medium according to claim 10, wherein the entitlements can be bought by a user from the digital store.

14. The medium according to claim 10, wherein the entitlements associated with the virtual object can be redeemed for game-world objects and/or services.

15. The medium according to claim 10, wherein the number of entitlements associated with a virtual object may change based on a variable factor within the game.

16. The medium according to claim 10, wherein the entitlements are for use with a different application or game.

17. The medium according to claim 10, wherein the user is allowed to sell or transfer the entitlements to another user based on rules of the game or gaming platform.

18. The medium according to claim 10, wherein the entitlements must be used within a predetermined period of time.
